(19) United States
(12) Patent Application Publication
(10) Pub. No.: US 2014/0146069 A1
(43) Pub. Date: May 29, 2014

(54) INFORMATION HANDLING SYSTEM DISPLAY VIEWING ANGLE COMPENSATION

(71) Applicant: DELL PRODUCTS L.P., Round Rock, TX (US)

(72) Inventors: Ben Jin Tan, Singapore (SG); Tze Fung Chung, Singapore (SG)

(73) Assignee: DELL PRODUCTS L.P., Round Rock, TX (US)

(21) Appl. No.: 13/688,509

(22) Filed: Nov. 29, 2012

(51) Int. Cl. G06T 3/60; G06T 11/00; G06F 3/01

(52) U.S. Cl. CPC G06T 3/60; G06F 3/011; G06T 11/001
USPC 345/589; 345/657; 345/156

(57) ABSTRACT

A viewing angle compensator adjusts the presentation of an image at a display so that the image has a uniform appearance to an end user at a viewing location. The angle of viewing from the viewing location to plural groups of pixels is used to compensate the pixel values in each group, such as the brightness, contrast and color presented by each pixel in each group, from original values to compensated values that make the picture appear uniform to the end user at the viewing location.

### BACKGROUND OF THE INVENTION

1. Field of the Invention

The present invention relates in general to the field of information handling system display devices, and more particularly to an information handling system display viewing angle compensation.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generate information for presentation at a display, such as documents generated by a word processing application, drawings generated by CAD or other drawing applications, pictures generated from compressed JPG files and movies generated from compressed MPEG files. Often, visual information is available for presentation with relatively high resolutions, such high definition movies presented from a Blu-Ray Disc player. End users tend to enjoy a better experience when high resolution visual images are presented at displays that have a generally larger viewing area. As the cost of liquid crystal displays (LCD) has decreased over time, many users have migrated towards the use of larger displays for use with information handling systems. For instance, 24 inch LCDs have become common in the work place. End users often find that a larger display benefits work efficiency by allowing simultaneous viewing of multiple documents and deeper inspection into high resolution images. In response, display manufacturers have provided displays to the marketplace with greater size, such as 27 inches or greater, and increased aspect ratios, such as 16:9 or 21:9 ratios of length versus height.

Display manufacturers will typically calibrate displays before shipment to retailers or end users. The displays are tested to ensure that overall screen provide an adequate color, contrast and brightness response. Imperfections introduced due manufacturing process limitations, such as cell gap differences, will cause an LCD panel to exhibit some color or brightness differences across a screen viewing area. A difficulty for calibration introduced by the use of relatively large display screens is that the viewing angle of an end user to a display can vary significantly across the viewing area of a display, especially with displays that have a wide aspect ratio. Even where individual pixels have uniform brightness or color, different viewing angles across the width and height of a display will cause an end user to experience some form of color and brightness differences at different sections of the display. The impact of viewing angle becomes apparent when displaying a full white screen at different viewing angles. Thus, even if an LCD screen has uniform color, brightness and contrast across all pixels, an end user will experience a less than optimal presentation of images. The end user experience will further suffer if the end user is himself off-center the display since viewing angles will increase for the more distal portions of the display.

### SUMMARY OF THE INVENTION

Therefore a need has arisen for a system and method which supports presentation of information at a display with compensation for an end user's viewing angle.

In accordance with the present invention, a system and method are provided which substantially reduce the disadvantages and problems associated with previous methods and systems for presenting information as visual images at a display. Visual information provided to a display is compensated based upon a view angle of an end user viewing the display to provide the end user with a uniform visual image. View angle compensation adjusts the presentation of the visual image to offset the effects of end user viewing angle on light distribution from the display.

More specifically, an information handling system processes information to provide visual information to a display, such as pixel values for presentation at a display. A viewing angle compensator, such a firmware instructions executing on a scaler processor of the display, compensates pixel values to correct for viewing angles associated with the pixels. For instance, pixels viewed from a greater angle are presented with increased brightness to provide a uniform appearance relative to pixels viewed from a lesser angle. View angle compensation values are stored in a compensation table of the display. Viewing angle compensation is applied for an expected end user position relative to the display. Alternatively, in one embodiment, an actual viewing position is determined by analyzing a camera image to determine the location of an end user relative to the display. In another embodiment, viewing angle compensation is further enhanced with adjustments to backlight LEDs across the display.

The present invention provides a number of important technical advantages. One example of an important technical advantage is that an end user experiences a more uniform presentation of visual images at a display. The display compensates for viewing angles that an end user experiences when viewing images so that the image appears uniform to the end user even though the presentation of the image by individual pixels is intentionally non-uniform. For example, a display is calibrated to have brightness and color variations for the anticipated viewing angles of an end user by estimating the distance from the screen at which an end user will view images and applying the estimated distance to the height and width of the screen. A typical adjustment will have a gradual increase in brightness for pixels as the distance of the pixels increases from the center of the viewing area. In one embodiment, the actual viewing angle experienced by an end user is determined from observations with a camera integrated in the display so that viewing angle compensation adjusts to an end user's position, even where the position is off-center.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system and display having angle of viewing compensation;

FIG. 2 depicts an example of viewing angles experienced by an end user viewing a flat panel display;

FIG. 3 depicts the example IPS display's white color shift for horizontal and vertical viewing angles;

FIG. 4 depicts the example IPS display's brightness change for horizontal and vertical viewing angles;

FIG. 5 depicts the example IPS display's contrast ratio change for horizontal and vertical viewing angles;

FIG. 6 depicts an example of a visual image viewing angle compensation performed with groups of pixels at plural location of a display;

FIG. 7 depicts three graphs that illustrate an inverse function used to provide uniform end user viewing; and

FIG. 8 depicts a flow diagram of a process for compensating pixel values of a display for angle of viewing.

### DETAILED DESCRIPTION

An information handling system display presents visual images having compensation for the angle of viewing at locations across the display relative to a viewing location. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes, For example, an information handling system may be a personal computer, a network storage device, or any other suitable device and may vary in size, shape, performance, functionality, and price, The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

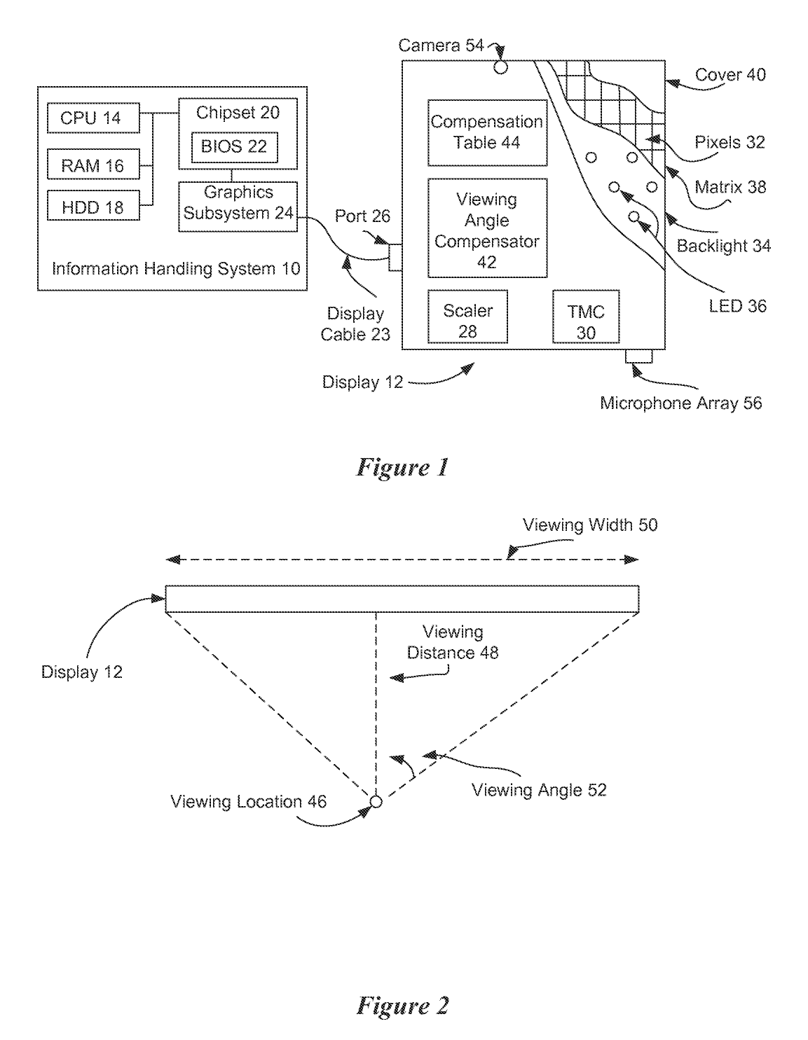

Referring now to FIG. 1, a block diagram depicts an information handling system 10 and display 12 having angle of viewing compensation. Information handling system 10 processes information through cooperation of processing components, such as a CPL 14 that executes instructions, RAM 16 that stores the instructions for access by CPU 14, a hard disk drive 16 that provides non-volatile memory to store applications having instructions and other information, and a chipset 18 that coordinates interaction of processing components on a physical level with a BIOS 20 and other firmware. As an example, hard disk drive 16 stores pictures and movies that are processed by applications running on CPU 14, such as picture viewers and movie players. CPU 14 executes picture viewer and movie applications to process picture and movie information stored in memory and provides the information to a graphics subsystem 24 to render visual information presentable by display 12 as visual images. For instance, graphics subsystem 24 generates pixel values for communication to display 12 through a display cable 23, such as a Displayport cable. Although FIG. 1 depicts information handling system 10 and display 12 as separate entities, integrated systems might also be used, such as laptops and tablets.

Pixel values from graphics subsystem 24 are provided to display 12 at a port 26 for further processing by a scaler processor 28 and for application by a timing controller 30 as pixel control signals to pixels 32. Visual images are generated at display 12 by passing light from a backlight 34, such as an array of LEDs 36, through a matrix of pixels 38 and out a clear or translucent cover 40. Pixel values applied by timing controller 30 adjust the form of liquid crystals at each pixel 38 to alter the color, contrast and brightness of light passing from backlight 34 through pixels 38 and out of cover 40. The example embodiment of FIG. 1 describes generally the operation of a liquid crystal display (LCD) and is not meant to limit the present disclosure to the described embodiment or to LCDs. In alternative embodiments, alternative techniques may be used to present visual images from pixel values that may have viewing angle compensation as set forth herein.

Display 12 presents visual images with brightness, color and contrast at pixels 38 generated from pixel values provided by graphics subsystem 24, however, the actual brightness, color and contrast of the visual image experienced by the end user depends upon the angle at which the end user views the pixels. In order to provide the end user with a uniform appearance for a visual image, a viewing angle compensator 42 running on a processor of display 12, such as scaler processor 28, adjusts pixel values to make the actual image non-uniform so that the visual image experienced by an end user appears uniform to the end user. For instance, an end user viewing the same pixel value at all pixels 38 from a viewing point centered in front of display 12 will see a visual image having less brightness, color and contrast at the edges of display 12. Viewing angle compensator 42 references a compensation table 44 to apply compensation values and algorithms that increase brightness, color and contrast for pixel values of pixels at the edge of display 12 so that the end user sees a visual image having a uniform appearance. In one embodiment, in addition to performing compensation by adjusting pixel values, viewing angle compensator 42 compensates brightness by adjusting LEDs 36 to provide greater brightness at greater viewing angles. LEDs 36 may be adjusted individually or in groups based upon their position in display 12.

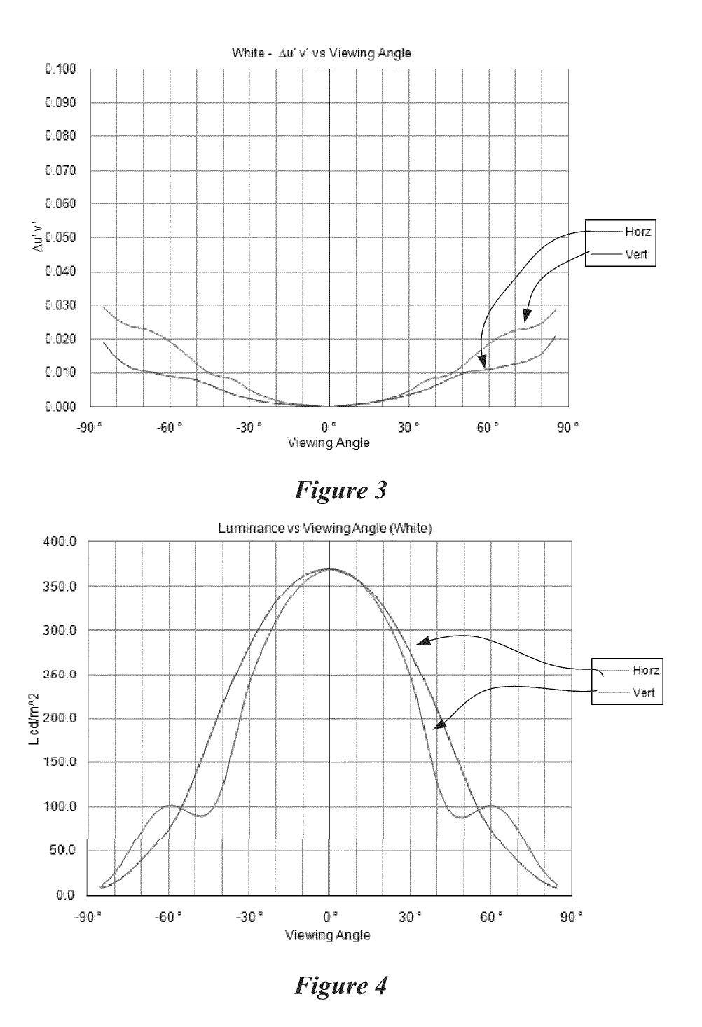

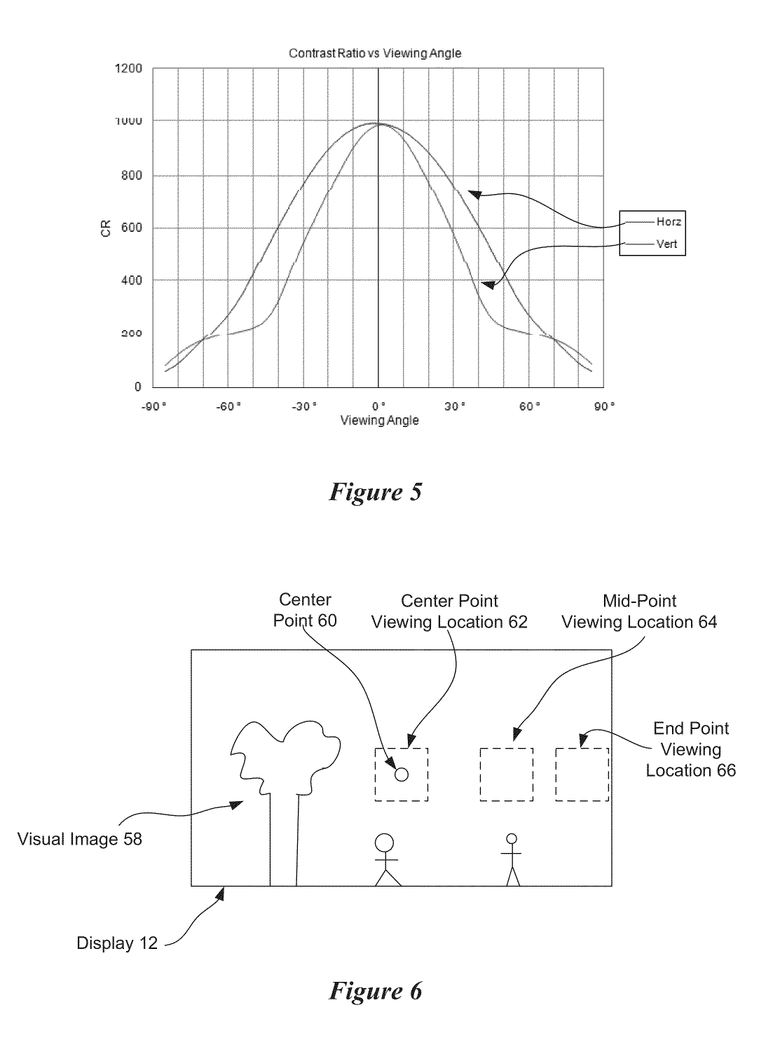

Referring now to FIG. 2, an example is depicted of viewing angles experienced by an end user viewing a flat panel display 12. In the example, a 27 inch LCD display 12 has a 16:9 aspect ratio. A typical end user viewing location 46 is depicted having a viewing distance 48 of 50 cm. The viewing width 60 of display 12 is 60 cm so that an end user in the example has a viewing angle of zero degrees for pixels at the center of display 12 and 30 degrees for pixels at the outer perimeter of display 12. In a typical premium grade IPS type LCD panel haying the dimensions of the example, variations between pixels having the same pixel value but 30 degrees difference in viewing angle are substantial enough for an end user to visually detect. For instance, one example display had a brightness of 370 nits at zero degrees and 280 nits at 30 degrees for a difference of 90 nits; a contrast ratio of 1000 at zero degrees and 780 at 30 degrees for a difference of 220; and a white color shift of zero at zero degrees and 0.004 at 30 degrees. FIG. 3 depicts the example IPS display's white color shift for horizontal and vertical viewing angles, FIG. 4 depicts the example IPS display's brightness change for horizontal and vertical viewing angles. FIG. 5 depicts the example IPS display's contrast ratio change for horizontal and vertical viewing angles.

Referring back to FIG. 1, viewing angle compensator 42 applies viewing angles for compensation based upon a typical viewing distance for a display 12, such as the 50 cm view distance depicted by FIG. 2. Alternatively, viewing angle compensator 42 detects the position of an end user and applies viewing angles for compensation based upon the detected position. As an example, a camera 54 captures an image of the area in front of display 12 so that viewing angle compensator 42 can analyze the image to determine the position of the end user. For instance, the automatic focus function of camera 54 provides distance information based upon the focus point. In addition, the image provides a position of the end user relative to a central position in front of display 12 so that an off-center end user's actual angle of viewing is computed with trigonometric functions based upon the dimensions of display 12. As another alternative, a microphone array 56 determines the angle to an end user based upon detection of sounds from the end user.

Referring now to FIG. 6, an example visual image 58 depicts viewing angle compensation performed with groups of pixels at plural location of a display 12. In the example embodiment, three separate groups of pixels are compensated based upon the position of each group relative to a center point 60 of display 12. Adjustments to pixel values for each group are performed by a scaler processor that independently controls brightness and color at different positions of display 12, such as scaler engine available from STMicroelectronics that uses zonal uniformity control. Pixels of display 12 may be divided up into 4096 zone locations, each capable of individual adjustment, however, groups that form 80×20 zone locations across display 12 provide adequate individual control for a uniform appearance to end users in most instances. As an example of groups of pixels that from viewing locations, FIG. 6 depicts a center point 60 has a center point location 62 with zero degrees of angle of viewing and no correction to pixel values or brightness. A mid-point viewing location 64 has 15 degrees of angle of viewing with moderate correction to color and increase in brightness. An end-point viewing location 66 has 30 degrees of angle of viewing with the greatest correction to color and increase in brightness. Each pixel within a location has the correction to color and increase in brightness applied for the angle of viewing associated with the location. Note that in an embodiment with image recognition, the location having zero angle of viewing might differ from the center location. For example, if an end user is aligned over end point viewing location 66, the correction to color and brightness would be moderate for mid-point location 64 and greatest for center location 62. In one example embodiment, viewing angle compensation is performed on a relatively small display, such as tablet or laptop integrated display, due to a detected end user position off-center the display. For instance, an improved tablet presentation is provided where a tablet is flat on a table and an end user is viewing the tablet from a sitting position off to a side of the table by detecting the end user's position and applying angle correction across the display for the off-center viewing location to make the display appear as it would if the end user were centered over the display.

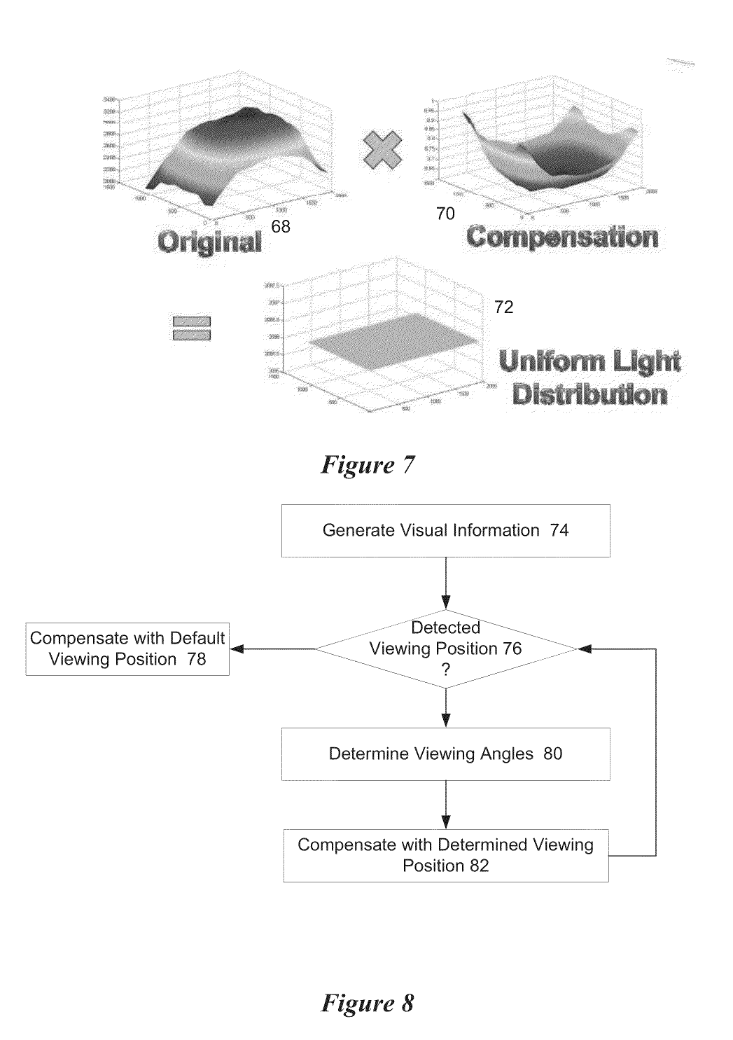

Referring now to FIG. 7, three graphs depict an inverse function used to provide uniform end user viewing. An original graph 68 depicts the relationship of color and brightness experienced by an end user with decreased color and brightness on the edge of the display caused by angle of viewing effects. A compensation graph 70 depicts color and brightness corrections that are the inverse of the display characteristics for brightness and color versus viewing angle. When a scaler processer applies the inverse characteristics presented by graph 70 to the original characteristics of the original display graph, the result depicted by graph 72 is a uniform light distribution presented to the end user. Calibration of color and brightness corrections for a display 12 is determined by testing the display and storing angle and brightness compensation information in compensation table 44 of display 12. Factory alignment is performed on an expected use case, such as an expected viewing location of an end user. Before shipping a display, the factory measures color variation dependency information for different portions of the screen versus viewing angle and stores the information in display memory, such as a series of polynomial equations that define corrections across the color spectrum. An end user can further calibrate the display after purchase using a colorimeter, such as the X-rite it Display Pro by placing a sensor on various locations of the display to measure the original performance. The original data is applied to viewing distance and viewing angles for the end user plus the correction data stored in display memory to create a uniform appearance for the end user.

Referring now to FIG. 8, a flow diagram depicts a process for compensating pixel values of a display for angle of viewing. The process starts at step 74 with generation of visual information into pixel values for presentation of a visual image at a display. At step 76, a determination is made of whether a detected viewing position is available, such as distance of angle information analyzed from an image captured by a camera. If detected viewing position is not available, the process continues to step 78 to compensate pixel values to a default viewing position with a default viewing distance and default viewing angles for locations across the display. If a detected viewing position is available, the process continues to step 80 to determined viewing angles from the detected viewing position. For example, viewing angles will vary depending upon the distance that an end user is from the display and depending upon whether the end user is off-center. At step 82, the pixel values are compensated for the detected viewing position and the process returns to step 76 to determine if a change in viewing position is detected.

Although the present invention has been described in detail, it should be understood that various changes, substitutions and alterations can be made hereto without departing from the spirit and scope of the invention as defined by the appended claims.

What is claimed is:

1. An information handling system comprising:
a processor operable to process information;
memory interfaced with the processor and operable to store the information;
a graphics subsystem interfaced with the processor and operable to process the information into visual information for communication to a display;
a display interfaced with the graphics subsystem and operable to present the visual information as images; and
a viewing angle compensator operable to compensate the visual information to adjust the images at plural locations of the display for an angle of viewing of each of the plural locations relative to a predetermined viewing location.

2. The information handling system of claim 1 wherein the predetermined viewing location comprises a predetermined distance from a central location of the display, the distance being to an anticipated end user viewing location.

3. The information handling system of claim 1 further comprising:
a camera interfaced with the viewing angle compensator and operable to capture an image of an area proximate the display;
wherein the viewing angle compensator analyzes the image to determine the predetermined viewing location.

4. The information handling system of claim 3 wherein the viewing angle compensator analyzes the focus of the camera image on an end user in the camera image to determine the distance of the predetermined viewing location.

5. The information handling system of claim 3 wherein the viewing angle compensator analyzes the camera image to determine an angle from a central portion of the display to an end user in the camera image to determine the predetermined viewing location relative to the central portion of the display.

6. The information handling system of claim 1 further comprising:
one or more microphones interfaced with the viewing angle compensator;
wherein the viewing angle compensator analyzes sounds detected by the one or microphones to determine the predetermined viewing location.

7. The information handling system of claim 1 further comprising:
a processor disposed in the display and operable to provide the visual information to display pixels for presenting the image;
wherein the viewing angle compensator further comprises instructions operating on the processor to compensate visual information provided to display pixels based upon an angle of viewing for the display pixels.

8. The information handling system of claim 7 wherein the viewing angle compensator compensates visual information by increasing the brightness of pixels having a greater angle of viewing relative to pixels having a lesser angle of viewing.

9. The information handling system of claim 7 wherein the viewing angle compensator compensates visual information by adjusting the color of pixels based upon the angle of viewing of the pixels.

10. The information handling system of claim 1 wherein the viewing angle compensator comprises instructions operating on the graphics subsystem to compensate visual information for an angle of viewing before the visual information is communicated to the display.

11. A method for presenting visual images at a display, the method comprising:
processing information into pixel values for presentation of a visual age at the display;
compensating at least some of the pixel values based at least in part on an angle of viewing position of display pixels; and
presenting the visual image with the compensated pixel values.

12. The method of claim 11 further comprising:
estimating an end user viewing position relative to the display; and
determining the angle of viewing position of display pixels based upon the angle between the estimated end user viewing position and the pixels.

13. The method of claim 12 wherein determining the angle of viewing position of pixels further comprises:
grouping adjacent pixels into plural location groups of the display; and
determining an angle of viewing compensation for each location group of the display.

14. The method of claim 11 further comprising:
detecting and end user position relative to the display with a camera integrated in the display; and
determining the angle of viewing position of display pixels based upon the angle between the detected end user viewing position and the pixels.

15. The method of claim 11 wherein compensating at least some of the pixel values further comprises increasing brightness of at least some pixel values having a greater angle of view relative to pixel values having a lesser angle of view.

16. The method of claim 11 wherein compensating comprises execution of instructions on a display processor.

17. The method of claim 11 wherein compensating comprises execution of instructions on a graphics subsystem of an information handling system interfaced with the display.

18. A display comprising:
plural pixels distributed across a panel, each pixel operable present a color defined by a pixel value;
a processor operable to coordinate application of pixel values received at the display to pixels for presenting a visual image; and
a viewing angle compensator stored in memory of the display and operable to adjust pixel values to compensate colors presented by pixels based upon the angle of viewing of the pixels relative to a predetermined viewing location.

19. The display of claim 18 further comprising a camera associated with the display and operable to capture an image of a pixel viewing area proximate the pixels, wherein the angle of viewing of the pixels is determined from analysis of an image captured by the camera, the image including an end user in the pixel viewing area, the position of the end user being the predetermined viewing location.

20. The display of claim 18 further comprising a backlight having plural LEDs, wherein the viewing angle compensator is further operable to adjust the brightness of the LEDs based upon the angle of view of the LEDs to the predetermined viewing location.
